(19) United States
(12) Patent Application Publication
(10) Pub. No.: US 2011/0236538 A1
(43) Pub. Date: Sep. 29, 2011

(54) CHITIN DERIVATIVE AND NATURAL SWEETENER CONJUGATE FOR CONTROLLING INGESTED FAT IN HUMANS AND HAVING SWEETENING PROPERTIES

(76) Inventors: Carlos M. Ochoa Mendoza, Bogota (CO); Manuel A. Bedoya Ospina, Manizales (CO); Andrés M. Rios Rojas, Medellin (CO)

(21) Appl. No.: 13/061,837

(22) PCT Filed: Sep. 2, 2009
(86) PCT No.: PCT/IB09/06786

§ 371 Date: May 31, 2011

(30) Foreign Application Priority Data
Sep. 2, 2008 (CO) 08092039

(51) Int. Cl. A23L 1/221

(52) U.S. Cl. 426/103; 426/658; 426/573

(57) ABSTRACT

The present invention provides a sweetener product which has the purpose of encapsulating ingested fat and stimulating the excretion thereof. The product is comprised of two compounds: a derivative of the amino sugar, chitin, and one or several sweeteners bonded through electrostatic interactions. This interaction contributes in improving neutral pH solubility and product presentation for human consumption.

The creation of the product assures homogeneity of its components in any dosage (through electrostatic interactions). The above in order to reduce any risk of unproportionate content in the different commercial presentations. Also, the carrier medium (sweetener) is cost efficient, used in mass consumption, and generates added value from a commercial perspective in the eyes of consumers.

### FIELD OF THE INVENTION

The present invention refers to a sweetener product having a normal sweetening intensity, involving in its composition an amino sugar derived from chitin in chemical association with a carbohydrate family sweetener or other type of natural sweetener, useful as a sweetener in several uses in foods and beverages, and at the same time allowing for ingested fat encapsulation. Likewise, the present invention also contemplates the preparation process of said sweetener product.

The present invention provides a product for human consumption which offers the possibility of encapsulating non-absorbable ingested fats and at the same time taste-agreeable sweetener properties. The use of substances which do not harm consumer health and which are also easily absorbable by the body are of great interest. Due to these and other reasons, we chose as raw materials the use of a common sugar (preferably saccharides) and a product known as amino sugar (preferably chitosan). The resulting final product from conjugating these materials shall be of potential use in dietary products, since the mentioned amino sugar has considerable strength in fat encapsulation in addition to other properties which shall be discussed below.

A preferred embodiment of the invention is a syrup presentation, which can be obtained as a preliminary step in the sweetener product obtainment process, through a drying control, thus providing different texture and color characteristics, which may be used as raw material in several industries, such as candy, natural beverages, soda, amongst others, since the color obtained in the products is inherent to them, avoiding the use of certain artificial colorants in beverages or candy. This embodiment overcomes problems related with the direct addition of chitosan without previous modification, which leads to precipitation of the colorant used in said products, either during the production phase or in the finished product as in the specific case of beverages.

The production and sale of sweetener products and sugar in Colombia and abroad includes a wide range of markets since its use through time has increased in all segments of the population. However, today there is a huge obesity problem in the world which generate the need for new alternatives for substituting caloric elements provided by substances such as sugars, sweets and candy which exist today and a growing interest for controlling and absorbing fat in the body. Both technical problems which persist in the art are embraced and solved in a novel and inventive manner by the present invention.

However, the art does not disclose any sugar which encapsulates fats, and which additionally provides antioxidant and preservative properties. This novel product which consists of bonding two molecules, a chitin derived amino sugar and a sweetener which allows for this type of bond (either from the carbohydrate family or any other type of natural sweetener, such as stevia), is of great interest and novelty for the market.

### THE ART

Chitin is a natural biopolymer (large molecule) extracted from crab, pawn, shrimp, lobster shells, insect exoskeletons, and some types of fungi. Structurally, it is a linear polysaccharide whose repetitive unit is β-(1→4)2-acetamide-2-desoxy-D-glucopyranose. From a chemical perspective, chitin is seen as a material which is very hard to treat, since it is insoluble in the majority of ordinary solvents such as water, alcohols, acetone, hexane, diluted acids and diluted or concentrated bases.

However, deacetylation of chitin using strong concentrated bases or through enzymatic methods, produces poly D-glucosamine or chitosan, which has a high amino group density and soluble in acid media, such as acetic acid, citric acid, ascorbic acid, lactic acid, amongst others. The following table describes chitosan's solubility in a range of acids at different concentrations.

TABLE 1
Chitosan solubility at different acid concentrations¹

| | % chitosan (g/100 mL) | | | | | | | | | |
|---|---|---|---|---|---|---|---|---|---|---|
| | 1 | 3 | 5 | 1 | 3 | 5 | 1 | 3 | 5 | |
| | [acid] (mol/l) | | | | | | | | | pKa |
| | 0.25 | 0.25 | 0.25 | 0.5 | 0.5 | 0.5 | 1 | 1 | 1 | (25° C.) |
| HCl | 1.4 (0.290) | 3.7 (0.250) | 6.2 (0.250) | 1.0 (0.600) | 1.2 (0.563) | 1.6 (0.525) | 0.6 (1.251) | 0.8 (1.158) | 0.9 (1.128) | — |
| Chloro- | 2.2 (0.028) | 2.8 (0.059) | 3.8 (0.112) | 2.0 (0.040) | 2.3 (0.058) | 2.6 (0.090) | / | 2.0 (0.070) | 2.2 (0.094) | 2.87 |
| acetic | | | | | | | | | | |
| Dichloro- | 1.4 (0.106) | 1.7 (0.106) | 4.6 (0.125) | 1.2 (0.167) | 1.3 (0.168) | 1.4 (0.172) | 1.0 (0.255) | 1.1 (0.259) | 1.1 (0.259) | 1.35 |
| acetic | | | | | | | | | | |
| Trichloro- | 1.1 (0.169) | 1.4 (0.144) | 3.3 (0.125) | 0.9 (0.279) | 0.9 (0.279) | 1.0 (0.267) | 0.6 (0.473) | 0.6 (0.473) | / | 0.70 |
| acetic | | | | | | | | | | |
| Formic | 3 0 (0.020) | 3.6 (0.052) | 4.7 (0.112) | 2.6 (0.019) | 3.1 (0.046) | 3.4 (0.078) | 2.3 (0.022) | 2.7 (0.043) | 2.9 (0.063) | 3.75 |
| Acetic | 3.9 (0.016) | 4.5 (0.045) | 5.1 (0.086) | 3.6 (0.017) | 4.0 (0.038) | 4.3 (0.066) | 3.2 (0.014) | 3.6 (0.033) | 3.8 (0.051) | 4.75 |
| Lactic | 2.9 (0.014) | 3.7 (0.051) | 5.3 (0.121) | 2.6 (0.016) | 3.1 (0.038) | 3.5 (0.076) | 2.3 (0.019) | 2.7 (0.034) | 3.0 (0.062) | 3.86 |
| Propionic | 4.0 (0.016) | 4.6 (0.046) | 5.3 (0.093) | 3.7 (0.017) | 4.2 (0.047) | 4.4 (0.067) | 3.4 (0.018) | 3.8 (0.042) | 4.0 (0.063) | 4.84 |
| Butyric | / | 4.6 (0.046) | 5.3 (0.093) | / | 4.1 (0.038) | 4.4 (0.058) | 3.6 (0.028) | 3.8 (0.043) | 4.0 (0.065) | 4.83 |
| Isobutyric | 4.0 (0.017) | 4.6 (0.048) | 5.3 (0.095) | 3.7 (0.019) | 4.1 (0.042) | 4.4 (0.071) | / | 3.8 (0.046) | 4.1 (0.083) | 4.80 |
| Divalent | | | | | | | | | | |
| acids | | | | | | | | | | |
| sulphuric | insoluble | insoluble | insoluble | insoluble | 0.9 (0.451) | insoluble | insoluble | insoluble | 1.1 (0.808) | — |
| | | | | | | | | | | 1.99 |
| oxalic | insoluble | 1.6 (0.114) | / | insoluble | 1.1 (0.184) | 1.4 (0.188) | / | 1.1 (0.288) | 1.1 (0.280) | 1.25 |
| | | | | | | | | | | 3.81 |
| succinic | 3.4 (0.026) | 3.8 (0.047) | / | 3.1 (0.024) | 3.4 (0.052) | 3.6 (0.088) | 3.1 (0.047) | 3.4 (0.103) | / | 4.21 |
| | | | | | | | | | | 5.64 |
| malic | 2.6 (0.020) | 3.1 (0.044) | / | 2.2 (0.021) | 2.7 (0.044) | 3.1 (0.087) | 1.9 (0.028) | 2.3 (0.042) | 3.3 (0.235) | 3.40 |
| | | | | | | | | | | 5.11 |
| maleic | 1.5 (0.066) | 1.9 (0.074) | / | 1.3 (0.098) | 1.5 (0.100) | / | 1.0 (0.154) | 1.2 (0.143) | / | 1.92 |
| | | | | | | | | | | 6.23 |
| Ascorbic | 3.0 (0.011) | 3.9 (0.053) | / | 2.8 (0.015) | 3.4 (0.047) | / | 2.5 (0.017) | 3 (0.043) | / | 4.04 |
| | | | | | | | | | | 11.51 |
| adipic | 3.8 (0.027) | 4.1 (0.050) | / | 3.8 (0.054) | 4.1 (0.099) | / | 3.8 (0.107) | 4.1 (0.199) | / | 4.43 |
| | | | | | | | | | | 5.28 |
| Trivalent | | | | | | | | | | |
| acids | | | | | | | | | | |
| phospho- | 1.8 (0.054) | 2.2 (0.072) | 1.4 (0.058) | 1.5 (0.076) | 1.7 (0.084) | 1.9 (0.101) | 1.2 (0.113) | 1.3 (0.111) | 1.4 (0.114) | 2.16 |
| ric | | | | | | | | | | 7.21 |
| | | | | | | | | | | 12.32 |
| Trans- | 2.1 (0.029) | 2.5 (0.047) | / | 1.8 (0.039) | 2.1 (0.050) | / | 1.5 (0.056) | 1.7 (0.057) | / | 2.80 |
| aconitic | | | | | | | | | | 4.46 |
| Citric | 2.4 (0.024) | 2.6 (0.043) | / | 2.1 (0.029) | 2.3 (0.038) | 2.6 (0.061) | 1.7 (0.036) | 1.9 (0.041) | / | 3.13 |
| | | | | | | | | | | 4.76 |
| | | | | | | | | | | 6.40 |

¹Hamdine, M., Heuzey, M. C., Béjin, A., 2005. International Journal of Biological Macromolecules. 37, 134-142.

Chitosan is a biodegradable polysaccharide comprised of two subunits, D-glucosamine and N-acetyl-D-glucosamine, joined by a β1,4 glycosidic bond. Its use in treating overweight problems or reducing cholesterol levels in humans has created great controversy. Studies exist which have produced both positive² and uncertain or negative³ results. However, it is observed that the experimental conditions used in these studies are not comparable. The type of chitosan, its molecular weight⁴, degree of deacetylation and solubility, are important factors which determine its activity. In addition, the presence of other components (for example, ascorbic acid) may substantially modify the ability of linking water and lipids⁵. Hence, the name chitosan is given a family of copolymers with different degrees of deacetylation and chain lengths; biodegradable, non toxic in animals (LD₅₀ 16 g/kg in mice)⁶, soluble in acid solutions and much more manageable than chitin. ²Bokura, H., Kobayashi, S., 2003. Eur. J. Clin. Nutr. 57, 721-725.³Pittler, M. H., Abbot, N. C., Harkness, E. F., Ernst, E., 1999. Eur. J. Clin. Nutr. 53, 379-381.⁴Sumiyoshi, M., Kimura, Y., 2006. Pharm. Pharmacol. 58, 201-207.⁵Kanauchi, O., Deichi, K., Imasato, Y., Kobayashi, E., 1994. Biosci. Biotech. Biochem. 58, 1617-1620.⁶Tsigos, I.; Martinou, A., Kafetzopoulos, D., Bouriotis, V., 2000. TIBTECH 18, 305-312.

The areas of application of chitosan include: water treatment, biomedical applications and personal care products⁷. Also, considerable attention has been drawn to oligomers of chitin and chitosan since they have exhibited certain interesting physiological activities, such as antitumor and antimicrobial activity. They are soluble in aqueous solutions⁸. ⁷Majeti N. V., Kumar, R., 2000. Reactive & Functional Polymers 46, 1-27.⁸Qin, C., Du, Y., Xia, L., Li, Z., Gao, X., 2002. International Journal of Biological Macromolecules. 31, 111-117.

Regarding the food industry, chitosan derivatives are accepted as ingredients of food products in countries such as Japan, Italy, and the United States.

Chitosan has demonstrated:
emulsifying ability, stabilizing double emulsions such of the water/oil/water type which has allowed its incorporation in low calorie formulations⁹;
preserving ability, having antifungal and antibacterial action, and hence used as preservative in food products;
gelling ability, since it precipitates at a pH greater than 6. ⁹Beysseriat, M., Decker, E. A., McClements D. J., 2006. Food Hydrocolloids 20, 800-809.

The distribution of the N-acetyl groups over the polymeric chain of chitosan allows for solubility control in a given solvent; in its natural state, it is soluble in aqueous acid solutions, for example acetic acid and those previously mentioned (table 1).

In particular, it can be said that chitosan is soluble in acidified water. This solubility and its viscosity are features which make it applicable in various uses. For example, in the human digestive system, chitosan traps fat present in the stomach which then leads through the intestine until its evacuation. Hence, in some applications, such as the nutrition field, it has been used as a body weight regulator and total cholesterol¹⁰ level regulator, whilst in the pharmaceutical arena, it is used as an active ingredient transport for drugs. ¹⁰Mattheus F. A. Goosen. Applications of Chitin and Chitosan. CRC Press. 1997

In addition, in the food industry chitosan is used to impart consistency and viscosity to salad dressings and mayonnaise; and it serves as an antimicrobial protector in fresh fruits and vegetables.¹¹ ¹¹Chien, P. J., Sheu, F., Yang, F. H., 2007. Journal of Food Engineering 78, 225-229

Further, it is known that chitosan in its dietary fiber presentation or high percentage deacetylation (DDA>70%) is soluble in aqueous acid solutions; however, at neutral pH (pH, 7.0), such as water for human consumption, chitosan does not change its fiber form and tends to agglomerate, i.e., does not solubilize.

Chitosan increases its ability to bind (trap) other substances, especially fatty acids, as solubilized fiber in an acid medium, due to its cationic nature; making it very attractive in the diet industry. In order to achieve high encapsulation strength, chitosan must have a very low percentage of acetyl groups or degree of deacetylation >70% (DDA 70%).

As established before, chitosan having a degree of deacetylation greater than 70% is soluble only in dilute acid solutions, and in order for it to dissolve in water, having neutral pH, it has been historically necessary to use an acidifying agent, in most cases being ascorbic acid.

Studies carried out by Argentine researchers which developed an experimental model of digestive chemistry simulates, in an in vitro model, the interaction process of chitosan with sunflower oil quantifying fat encapsulation percentage developed by different types of chitosan in the human digestive system, showing that both the degree of deacetylation as well as molecular weight (in this case viscosity) are fundamental study parameters regarding fat encapsulation.¹² ¹²Rodriguez, M. S. y Albertengo, L. E., 2005. Biotechnol. Biochem., 69. 2057-2062.

Furthermore, the object of the present patent application is to obtain a conjugate comprised of a sweetener, which serves as a cost effective carrier and is attractive to the consumer, and a chitin derivative, bonded by electrostatic interactions, soluble at a neutral pH and allowing homogeneity of its elements in any presentation.

The inventors have knowledge of Japanese patent JP 11021302 which teaches the inclusion of a chemically modified acidic saccharide in chitosan in order to achieve solubility at neutral pH; this comparison shall be discussed later.

In the diet fiber market, a fat encapsulating product must be taken before each meal in the form of tablets and/or capsules, which include other ingredients in addition to chitosan which aid in activating its encapsulating strength; this is achieved through a physical blend in solid phase. Obtaining a product wherein chitosan is present and which may be consumed together with a meal is of great interest, thus avoiding tablet consumption. It may also be used as an ingredient in the pastry industry.

Further, syrup presentations may be useful as raw material in a wide range of industries; and knowing the fact that the precursor in itself (chitosan) can link colorants, this embodiment offers the possibility of avoiding the use of some artificial colorants used in the food industry (beverages, natural juices, candy, others) since this product has its own colorant property.

### DETAILED DESCRIPTION OF THE INVENTION

The object of the present invention is to provide a sweetener product, soluble in water and which encapsulates ingested fats in the body, comprising a chitin derivative (preferably chitosan) molecularly bonded with a sugar (carrier), preferably any saccharide as a cost effective alternative and agreeable to the consumer of body weight control products.

In developing the invention, several aspects in producing a chitosan-sugar product were considered:

a) Making chitosan water-soluble. In this first aspect, chitosan is modified in order to make it water-soluble under neutral pH conditions, such as for example water. Once the chitosan is conjugated with the sugar, the coexistence of both molecules under the same solution medium is achieved.
b) Using chitosan having a high deacetylation (DDA>70%) percentage. In this aspect, chitosan's most attractive functionality is fiber due to its high encapsulating strength and which is not digestible in the body. Also, chitosan having different molecular weights (or different viscosities) ranging from low to medium (3-300 kDa) were used in order to establish which of them showed better encapsulation features quantified by an in vitro test according to a protocol by Rodriguez and Albertengo¹³. However, this form requires the company of an acid in order to achieve dissolution of the material in further conjugation with the carbohydrate. ¹³Rodriguez, M. S. y Albertengo, L. E., 2005. Biotechnol. Biochem., 69. 2057-2062.

Consequently, an embodiment of the present invention refers to the development of a chitosan solubilizing procedure in neutral pH media, consisting of starting from native chitosan having a DDA>70% and a certain chain length in order to obtain chitosan having about the same DDA, but a much small chain length in comparison to the original without becoming an oligosaccharide.

The coexistence of molecules within the crystalline lattice is based on the probability that one molecule having a certain electrical or ionic affinity joins or gets close to another molecule and interact through hydrogen group affinity (H⁺), bonding amongst themselves one by one through hydrogen bonds or through other types of electrostatic interactions (for example, Van del Waals forces). This alternative has the advantage it does not contribute a chemical change in the precursors thus keeping their entire functionalities.

In order to obtain a hydrogen bond, the molecules involved must be suspended or solubilized in a medium wherein they are not chemically altered, being imperative they be in the same phase so said molecules can be available to intermolecularly bond.

According to Flory-Huggins^{14 15} polymer blend thermodynamics, polymer miscibility and compatibility is essentially conditioned to the formation of specific interactions amongst them which ultimately contribute in reducing or making blend enthalpy (AIL) negative. Formation of hydrogen bonds between macromolecules of two different substances competes with the formation of hydrogen bonds with molecules of the same species, wherein the latter interactions do not contribute with ΔHₘ. It is thus foreseen that hydrogen bond strength and steric effects be determined by compatibility and miscibility of two polymers.¹⁶ ¹⁴P. J. Flory, Principles of Polymer Chemistry, Cornell Univ. Press, New York (1953).¹⁵R. H. Boyd, P. J. Philips, The Science of Polimer Molecules, Cambridge University Press, New York (1993)¹⁶González, V. A., Guerrero, C. A., Méndez, U. O., 2001. Ingenierias, Vol. IV, No. 13, 9-19.

Considering chitin structure analysis, four different types of hydrogen bonds may be established:

I). Between two hydroxyl groups (OH—HO).
II). Between hydrogen of an amide group and the oxygens of hydroxyl groups (HO—HN)
III). Between hydrogens of hydroxyls and a carbonyl group (C═O—HO).
IV). Between the hydrogen over nitrogen and a carbonyl group (C═O—HN).

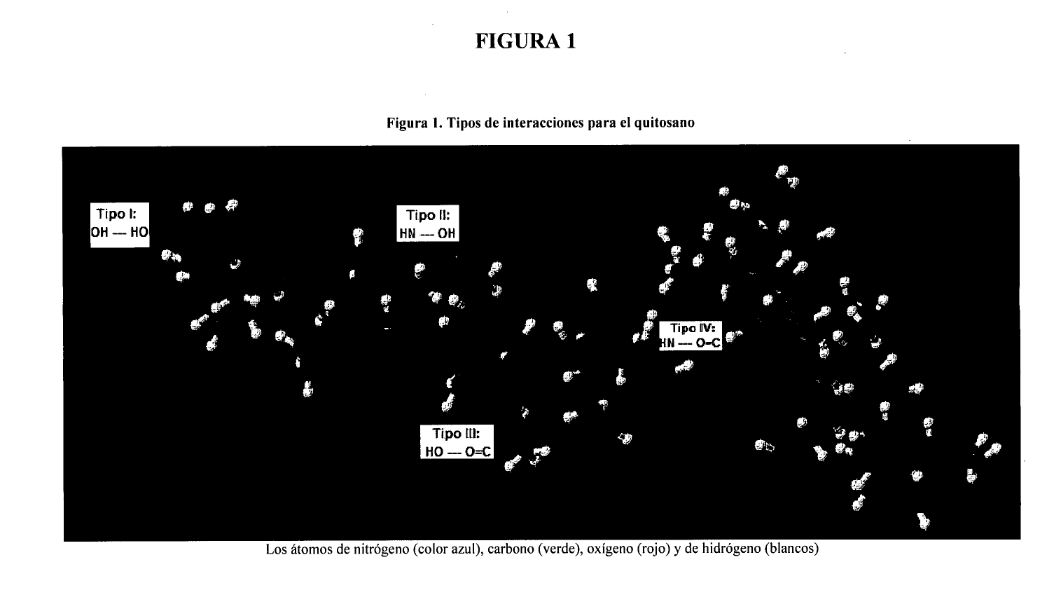

In FIG. 1, these types of interactions are shown in the case of chitosan, wherein two polymeric chains are established each with 3 glucosamine units and 1 acetyl-glucosamine unit.

Chitin deacetylation when obtaining chitosan implies carbonyl group reduction, thus, in this deacetylated form, a lesser number of possible hydrogen bonds exists wherein carbonyl groups intervene (C═O—HO and C═O—HN), which are much stronger than any other hydrogen bond. Furthermore, it is foreseen that chitosan be more effective in hydrogen bond formation with another polymer, i.e., the formation of a sugar-chitosan compound.

In order to intermolecularly link a sugar with chitosan it is necessary to study the solubilization medium allowing for these components to be in same phase and thus making their chemical interaction possible. The invention's solvent (low concentration food grade acids) is preferred due to economical and functional reasons since chitosan, an essential component of the invention, is insoluble in water. On the other hand, using sugars in concentrated acid or basic media may pose reactivity problems causing chemical, structural and functionality modifications in the sugar; this problem was found in other studies, such as Japanese patent JP 11021302, wherein a carbohydrate undergoes a structural modification in order to be linked to chitosan and hence provide neutral pH solubility properties. Therefore, it is an object of the invention to avoid high concentrations of said dissolution media and/or precursor structural or functionality modifications.

In order to carry out the present invention, two steps were followed: a first step comprising the modification of native chitosan in order to achieve its solubility in neutral pH ranges; and a second step, starting from commercial chitosans having known physicochemical properties (viscosity and deacetylation degrees) and incorporating a third agent or solubilization medium which eases interaction between the chitosan molecule and the sugar without interfering with the functionality of said precursors.

### First Stage

The present invention involves three fundamental concepts: (i) pre-treatment of native chitosan, (ii) preparing its solubility, (iii) synthesis with sugars.

The need for having the two coexisting molecules without modifying their original properties and above all their characteristic functions, makes it imperative that the invention carry out a specific modification of chitosan ultimately having desired neutral pH solubility characteristics where it would be more feasible for it to interact with sugars in a foreseeable manner. In order to obtain neutral pH solubility, different processes exist; as a non limiting example, there is the acid hydrolysis depolymerization method where basically the polymer chain length is reduced using a reaction in a concentrated acid medium and increased temperature in order to improve chitosan's solubility. This method will be discussed in further detail below.

A type of chitosan modification carried out to improve its solubility at neutral pH using saccharides has been found in literature, which consists in forming a Schiff base through reductive alkylation reaction, which uses lactic acid as an additive and the compound sodium cyanoborohydride (NaCNBH₃) in order to modify chitosan by inserting the saccharide in the form of an aldehyde. Table 2 compares different combinations made of chitosan 88 (88% deacetylation) and different saccharides according to the solubilization range obtained.¹⁷ ¹⁷Sashiwa, H., Shigemasa, Y., 1999. Carbohydrate Polymers 39, 127-138

Chitosan is a polysaccharide having important stiffness characteristics, i.e., its polymer chain makes this molecule's conformational tendency (spatial distribution) to happen intramolecularly (inside) leaving very little space for it to join the sugar. Therefore, the most recommendable option is to redistribute the polymer chain size (presenting the chain in smaller units), achieving greater probabilities that chitosan molecules will face sugar molecules in the finished product.

Chitosan distributed in smaller chains and deacetylized (soluble in neutral pH) is found in a favorable state so it can conjugate in one sole medium with sugar and hence, through charge affinity and hydroxyl group density, sugar and chitosan molecules will attract each other and with further reaction medium extraction, these molecules will associate through electrostatic interactions (for example hydrogen bonds) ultimately arriving at the formation of a conjugate formed by chitosan-sugar without modifying its functionality.

### Second Stage

In a second laboratory development stage, the encapsulating strength of the molecule obtained in the previous step was tested using an in vitro fat encapsulating test. This test reported by an Argentine research group consisted of simulating the human digestive system behavior (stomach and duodenum) by testing the effect of microemulsions generated by chitosan in the water-oil-water system, as well as quantifying oil trapping capacity which products prepared in step 1 present through experimental analysis methods.

In addition, researchers also opted to use a range of commercial chitosans having different physicochemical properties (molecular weight or viscosity and deacetylation degrees) which are characterized for having molecular weights ranging from low and medium, in relation to the hypothesis set forth in the previous laboratory development stage. Further, these materials were tested in order to quantify their fat trapping effect in the in vitro test which shall be explained below.

Table 3 shows the characteristics of the commercial materials taken under consideration:

TABLE 3
Physicochemical characteristics of the commercial precursors

| | | Molecular | Degree of | Viscosity | |
|---|---|---|---|---|---|
| Sample No. | Description | weight (kDa) | deacetylation (%) | (mPas or cps) | Amount (g) |
| 1 | chitosan oligosaccharide | <3 | 84-86 | — | 50 |
| 2 | chitosan oligosaccharide | 3-5 | — | — | 50 |
| 3 | chitosan oligosaccharide | 8-10 | — | — | 50 |
| 4 | water soluble chitosan | — | 84-86 | 20-40 | 50 |
| 5 | chitosan | — | 94-96 | 30-50 | 50 |
| 6 | high density chitosan | — | 90-92 | 40-60 | 50 |
| 7 | chitosan | — | 90-92 | 50-70 | 50 |
| 8 | chitosan, Industrial grade | — | 84-86 | 90-110 | 50 |

It is important to carry out tests in this stage of development, using commercial chitosans obtained, particularly regarding two properties: solubility range and fat encapsulating strength; for this, tests of the different materials were carried out.

As was expected, materials named such as chitosan oligosaccharides were soluble in neutral pH whilst the rest required the use of an acid medium. This confirms the use of the second alternative named above, which is based on use of a low concentration acid which allows for precursor solubilization without affecting functionality of both said precursor as well as the sugar.

As mentioned in the field of the invention, JP 11021302 developed a modified chitosan through the inclusion of an acid saccharide in order to obtain neutral pH solubility of said material; the acid saccharide is produced from the chemical modification of a sugar, in alcohol solution, with inorganic or carboxylic acids in its chemical structure. The preferred embodiment of this invention however is achieving the conjugation of a chitosan with a saccharide including a low concentration food grade acid, without modifying their physicochemical properties.

Bonding of chitosan type molecules and sucrose is an innovative development; since this bond is not found in nature as such, but instead needs of a process which allows the interaction of these precursors. In order to make chitosan soluble in the same sugar medium, a pre-treatment of said molecule is necessary which allows for no floating residues which would generate an unpleasant taste sensation when using the final product in a beverage, and at the same time would improve the visual presentation for the consumer. In addition, the conjugate obtaining process is also novel which consists of a simple method which eases industrial production in highly homogenous dosage presentations requiring simple equipment which reduces production costs.

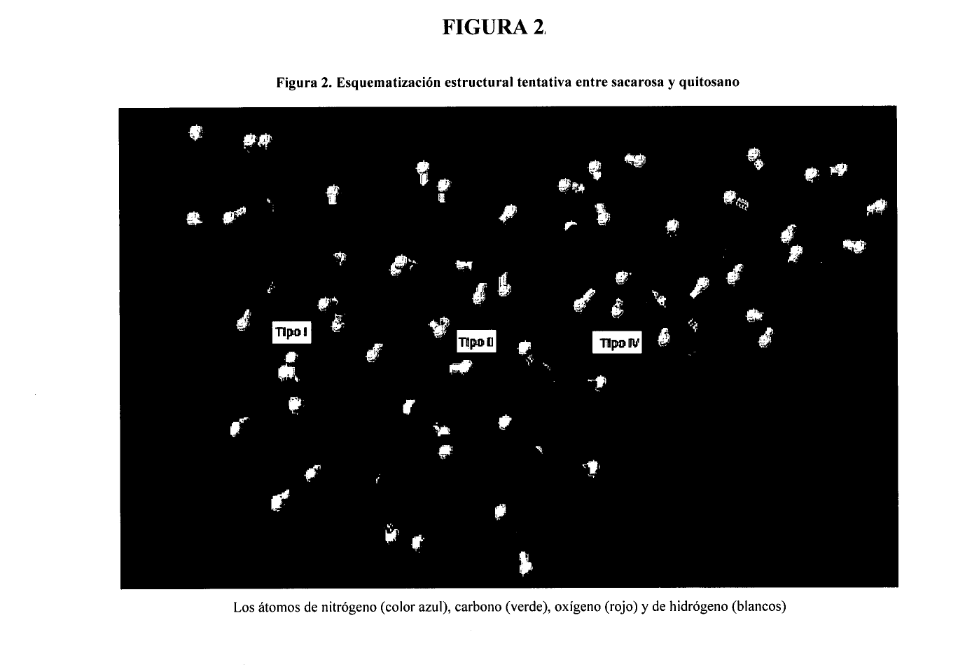

In FIG. 2, interaction between a sucrose unit and a polymer chain of chitosan comprised by 3 units of glucosamine and 1 unit of acetyl-glucosamine is shown. It is worth noting that these interactions can arise simultaneously and/or individually.

A wide range of sources exist in order to obtain the invention's precursors such as chitosan and sucrose, said precursors being renewable and of low environmental impact. However, the present invention in no way is limited to the previous chitosan-sucrose embodiment since any normally skilled artisan could easily appreciate that this invention comprises aspects such as the use of different sugars which would behave similarly to sucrose, re its functional properties. For example, the present invention contemplates the selection of sugars amongst a group comprised of fructose, glucose, galactose, lactose, sucrose and invert syrups amongst the group of carbohydrates which would also serve as a carrier medium. The use of natural sweeteners also offers an interesting possibility as a precursor source; for example, the use of rebaudian stevia is contemplated. Additionally, the present invention does not permit that intermolecular coexistence of the sugar and chitin derivative cause any unfavorable modification in them.

Consequently, the problem to be solved with the present invention is to provide a product having the following characteristics: (i) sweetener, (ii) fat encapsulating property (iii) antibacterial (iv) greater shelf life and (v) antioxidant strength.

The challenge in creating a product having the desired characteristics, which can also be produced in any homogenous dosage form, and being very commercial, lies in understanding precursor functionalities and conditions said precursors need in order to support its coexistence. Hence, the present invention has determined that taking advantage of chitosan's physicochemical properties, DDA>70% and molecular weight ranging from 20 to 300 kDa (fat encapsulating activity), the effect of additives (preservative and antioxidant activity) and DDA 40-65% (having antimicrobial properties), useful in the food industry, and also understanding the limited solubility concept at neutral pHs, the determination of opting for both alternatives is taken in order to obtain a final product which provides the advantages of both precursors in one sole presentation, i.e., a sweetener and a fat encapsulator is obtained in one product at the same time.

In terms of industrial level production, the development of a chemical bond amongst these types of molecules represents the most efficient form in order to offer a product in a physical package similar to that of commercial sugar in any of its presentations. In addition, the processes of scaled production are shown to be simple, cost efficient and feasible. A supplemental embodiment is contemplated consisting of presenting the product in the form of gels and/or syrups, useful as raw material in different food industries.

Because a difference between molecular weight amongst these two components exist (sucrose and chitosan), a direct physical blend is not simply possible since a homogenous product would not be assured in each packaging unit. Therefore, the modification mentioned herein is opted for due to the small chitosan dosages required in the final product, since excess chitosan consumption may produce counterproductive effects in the human body.

A product obtained through physical blend would normally have an irregular presentation and would not be homogenous. Therefore, an embodiment of the present invention intends to improve product distribution (homogeneity) in order to assure uniformity in required amounts of the encapsulating agent in each commercial unit. Also, a sweetener compound is provided having preservative properties due to the effect of the chitosan precursor, which prolongs shelf life thereof, and the presence of low concentration acids offer antioxidant properties.

Hence, the present invention allows for industrial development in normalized conditions of a fat encapsulating sweetener complying with the double task of sweetening and body fat clearance.

### Procedure

In order to obtain a molecule having diet applications and sweetener properties having the ability to bond lipids and water, it is necessary to establish certain parameters such as the type of precursor (chitosan), its molecular weight, and degree of deacetylation. These characteristics may be achieved in different ways, either acquiring the material having the desired characteristics directly from a commercial supplier, or through native chitosan modification, through chemical, enzymatic, mechanical or biological methods.

Amongst the chemical methods the following are found: acid hydrolysis with hydrochloric acid¹⁸, heterogeneous degradation with hydrogen peroxide¹⁹, chitosan preparation through enzymatic hydrolysis²⁰, phosphoric acid²¹ degradation, chitosan degradation through microwaves²², amongst others. ¹⁸Rhazi, M., Desbrieres, J., Tolaimate, A., Rinaudo, M., Vottero, P., Alagui, A., 2002. Polymer 43, 1267-1276.¹⁹Huang, Q. Z., Wang, S. M., Huang, J. F., Zhuo, L. H., Guo, Y. C., 2007. Carbohydrate Polymers 68, 761-765²⁰Muzzarelli, R. A. A., Orlandini, F., Pacetti, D., Boselli, E., Frega, N. G., Tosi, G., Muzzarelli, C., 2006. Carbohydrate Polymers 66, 363-371.²¹Jia, Z., Shen, D., 2002. Carbohydrate Polymers 49, 393-396.²²Xing, R., Liu, S., Yu, H., Guo, Z., Wang, P., Li, C., Li, Z., Li, P., 2005. Carbohydrate Research 340. 2150-2153.

### TECHNICAL EXAMPLES OF THE PROCESS

### First Stage

### Example No. 1

### Capillary Viscosimetry Protocol

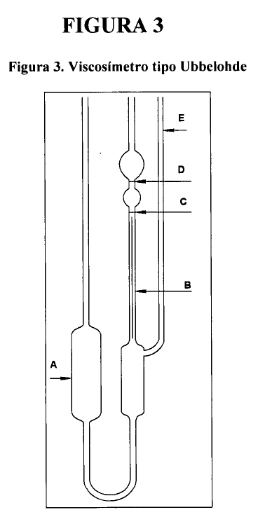

This method is advantageous in the sense it does not require complex equipment in order to carry out analysis (FIG. 3); likewise, it is valid when determining average molecular weight of a material is desired. As for polymers, it is quite useful since it does not need high concentrations thereof. In order to assure precision when reading, the temperature reading must have a variation range off ±0.02° C.; and the flow measured time must not exceed 100 seconds²³. The procedure for this method is as follows:
1. Add the liquid to tube A, keeping tube E capped.
2. With the aid of a pump, elevate the liquid until the meniscus is above level D.
3. Uncap tube E and doing so the liquid will freely descend.
4. When passing meniscus past level D, time used begins to be measured and is logged until meniscus passes level C²⁴.
5. Once equipment is calibrated, Ubbelohde constant is calculated.
6. Prepare problem sample and carry out steps 1 through 4. Solutions must be shown in such a manner they cover a mass range between 0.2 and 1 g (preferably in 0.05 g intervals).
   Note 1: Reading is carried out in triplicate both for standards was well as for blends.
   Note 2: Keep internal temperature of Ubbelohde at 25° C., using thermostat bath. ²³Floy, P. J. Principles of Polymer Chemistry. Cornell University Press. Ithaca, N.Y., 1953. pag 308.²⁴Romero, C. M., Blanco, L. H., Tópicos en quimica básica. Experimentos de laboratorio. Academia Colombiana de Ciencias Exactas, Fisicas y Naturales. Colec. Julio Carroza Valenzuela No 5. 1996. 141-144.

### Example No. 2

### Depolymerization by Acid Hydrolysis

Since native chitosan is a high molecular weight polysaccharide, it has high rigidity chain characteristics, solubility in acid media and non-linear polymer spatial distribution, being necessary a structural modification in order to improve neutral pH solubility.

Since a molecule soluble in media similar to water is desired, it is necessary to carry out a depolymerization procedure on native chitosan, in order to improve neutral pH solubility and increase its ability of homogenous bonding with the saccharide of choice.

Depolymerization by acid hydrolysis consists of a high concentration acid in order to reduce the polymer chain, bringing it down to a low or medium molecular weight (LMW or MMW) and empowering it for further combination with the saccharide.

### Sample Preparation

weigh a mass of chitosan between 5 and 10±0.5 g, having a DDA=94±2% and a molecular weight MW≈780,000 Da.
prepare HCl solutions between 6-8 N.

### Reaction

Add the previously weighed chitosan in the HCl solution (hydrochloric acid) having different chitosan mass/HCl volume ratios in solution (for example, 5±0.1 g chitosan/200±1 ml HCl 8N), gently shake for a certain time (t=4 at 120±0.1 h); keeping the depolymerization reaction at the same temperature conditions between room temperature and 50±2° C. The reaction conditions used are presented as follows:

TABLE 4
Experimental conditions for depolymerization

| | Chitosan | Volume | Concentration | time | Tempera- |
|---|---|---|---|---|---|
| Sample | mass (g) | HCl (ml) | HCl [N] | rxn (h) | ture (° C.) |
| 1 | 4.999 | 100 | 6 | 87 | 19 |
| 2 | 9.784 | 100 | 6 | 87 | 19 |
| 3 | 10.06 | 200 | 8 | 111.63 | 30.6 |
| 4 | 5.007 | 100 | 8 | 88.17 | 50 |
| 5 | 10.002 | 200 | 8 | 63.00 | 21 |

### Precipitation

In order to precipitate LMW or MMW chitosan, a sodium hydroxide solution is prepared (NaOH between 10-20±1% w/v) as is slowly dripped until a pH of 9-11 is reached; it is left still for about 2±0.1 h.

### Separation

After the reaction time lapsed, solid phase is separated from liquid phase through centrifuge.

### Washing

It is washed using double distilled water (DDW) until a pH close to 8, then using ethanol (C₂H₆O) until obtaining an almost neutral pH, with further evaporation to remove possible ethanol traces. The entire procedure is carried out together with centrifuges in each step.

### Drying

The LMW or MMW chitosan is subject to drying by temperature increase in an oven between 40 and 70±2° C. between 72 and 96±0.1 h, in order to remove intramolecular water present.

A preliminary step in the above protocol was carried out in laboratories at the Universidad Nacional de Colombia, Manizales campus, whose purpose was to obtain precursors having a degree of deacetylation (DDA) greater than 75%, from a medium molecular weight range between 20 and 300 kDa, as precursor characteristics for product optimization.

Several preliminary depolymerization tests were carried out for “depolymerization through acid hydrolysis” in order to obtain small polymer chains. After depolymerization, the average molecular weight was calculated using the “capillary viscosimetry” method discussed before. Table 5 shows molecular weight values obtained experimentally.

TABLE 5
Capillary viscosimetry results for products of stage 1.

| Sam- | | Avr Mo- |
|---|---|---|
| ple | | lecular |
| No. | Characteristic | weight (Da) |
| 1 | Crown chitosan (BC), before the naked eye | 35.685 |
| 2 | possesses impurities. Low molecular | 35.469 |
| 3 | weight precursor | 53.959 |
| 4 | | 49.531 |
| 5 | Polymer obtained through depolymerization of BC | 7.292 |
| 6 | Polymer obtained through depolymerization of BC | 4.441 |
| 7 | Polymer obtained through depolymerization of BC | 10.501 |
| 8 | White chitosan (WC), before the naked eye lacks | 449.439 |
| | impurities. Powder presentation. Medium | |
| | molecular weight precursor | |
| 9 | Polymer obtained through depolymerization of WC | 9.310 |
| 10 | Polymer obtained through depolymerization of WC | 13.849 |
| 11 | Polymer obtained through depolymerization of WC | 13.437 |
| 12 | Polymer obtained through depolymerization of WC | 19.782 |
| 13 | Polymer obtained through depolymerization of WC | 23.354 |

The values highlighted in the above table are the preferred materials for use in the following stage, because the pH obtained in the precipitation reaction is approximately 7.

### Example No. 3

### Synthesis of the Molecule in the First Stage

The precursor obtained in the process described above (low or medium molecular weight chitosan) supposedly water soluble is conjugated with sucrose taking advantage of the same solubilization medium.

Considering the hydrogen bond formation concept between chitosan and sucrose, an oversaturated sucrose solution was prepared in order to reduce the amount of bonds between hydrogen and water and accelerate the final crystallization process; furthermore, depolymerized chitosan is introduced in the sucrose matrix, said process being helped by gentle shaking.

The high concentration of sucrose may influence parameters such as: greater possibility of substituting LMW or MMW chitosan instead of water molecules, better configuration of intermolecular LMW chitosan-sucrose or MMW-sucrose hydrogen bonds, instead of LMW chitosan-water-sucrose or MMW chitosan-water-sucrose, chitosan-water and sucrose-water, case accordingly; i.e., presence of water within the crystalline lattice reduces the possibility of chitosan-sucrose intermolecular hydrogen bonds, and process efficiency.

Synthesis conditions are the following:
1. 32±0.1 g of sucrose in 25±1 ml of water (synthesis 1), in order to obtain an oversaturated sucrose solution, about 2.5±0.1 g of depolymerized material was added, which represents 7.3% in weight; gentle shaking during a reaction time of 4±0.1 h, keeping pH close to 7.
2. 35±0.1 g of sucrose in 25±1 ml of water (synthesis 2), in order to obtain an oversaturated sucrose solution, about 2.5±0.1 g of depolymerized material was added, which represents 6.6% in weight; gentle shaking during a reaction time of 16±0.1 h, keeping pH close to 7.

In solid phase, sucrose and chitosan cannot be combined (physical blend) due to their considerable molecular weight difference, since through this method the possibility of hydrogen bond formation would not exist thus forming a very unstable and non-homogeneous blend. A crystallization process due to elevated temperature increase could disable for the most part the existence of hydrogen bonds, due to water molecule mobility, sucrose molecule redistribution and a possible generation of undesired intermediate products.

### Crystallization

The process carried out for crystallization of the synthesized molecule (chitosan-sucrose) is low temperature heating crystallization, as explained above; the use of high temperatures was not contemplated as a feasible option. In addition, recrystallization of sucrose at high temperature leads to inversion and color change thereof, harming commercial presentation.

In order to optimize low temperature heating it is recommendable to use vacuum in order to accelerate crystal growth in the solution; considering reports of researchers that work with chitosan, derivatives thereof and polysaccharides²⁵ in general. Therefore, the most recommendable process for crystallization of this type of molecule is cold crystallization (for example freeze drying) which has greater yield due to low pressure management which sublimates water contained in the crystals without producing heat damage in the new molecular formation. The elevated presence of water bonded to chitosan cationic cores through intramolecular bonds within the crystalline lattice requires of a greater amount of energy in order to be ejected from said sites. ²⁵M. Mathlouthi, J. Genotelle. 1998. Carbohydrate Polymers 37, 335-342

### Example No. 4

### Physicochemical Analysis

Instrumentation techniques or physicochemical analysis are useful in order to determine and establish structural, morphological, thermodynamic properties amongst others of materials under review. For example, functional groups and interactions existing between polymers, i.e., hydrogen bonds, may be detected through vibrational techniques; for example widening or running of infrared absorption bands of functional groups involved. The tendency for polymers to separate at macroscopic levels when compatibility exists and to blend at microscopic levels when miscibility exists makes the use of microscopic techniques feasible in order to evaluate distribution of said molecules. Changes in chemical potentials translate into melting temperature and enthalpy reductions, in addition to glass transition temperature shifts, phenomena which may be analyzed using differential scanning calorimetry (DSC).^{26 27} ²⁶Painter, Y. Parker, M. Coleman, J. 1998. Appl. Polym. Sci. 70(7), 1273²⁷Silverstein, Bassler and Morril, Spectrometric Identification of Organic Compounds, John Wiley & Sons, New York, (1981)

### Analysis of Infrared Spectroscopy Results Using Fourier Transformation (FTIR)

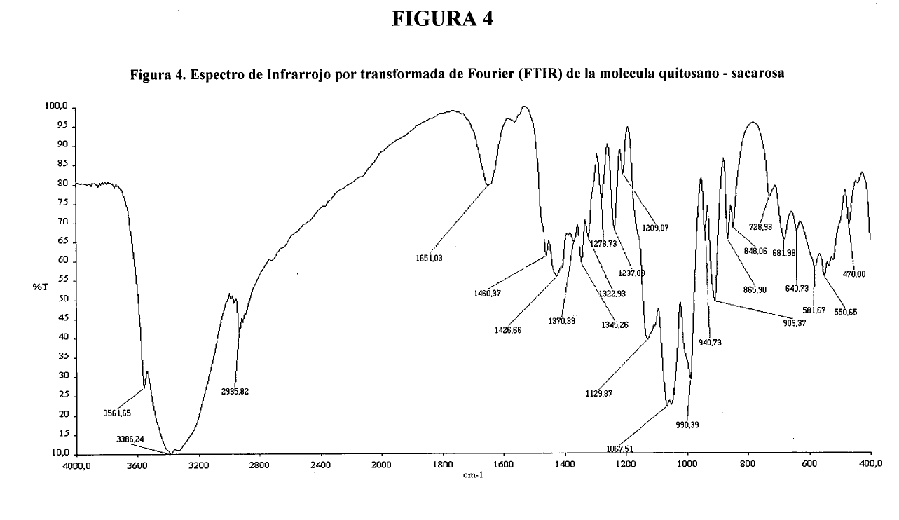

In order to correctly interpret the infrared spectra obtained (FIG. 4), the specific functional groups that the precursors of the final molecule present must be initially established. It is also important to highlight different regions of the same spectrum to be able to suggest in a clearer manner the coexistence or not of sucrose and chitosan molecular formation.

The 4000-2500 cm⁻¹ region suggests the presence of —OH groups either through intra o intermolecular bonds, —CH, —CH₂, —NH; in the 1800-1500 cm⁻¹ region, the amide groups (primary and secondary) are found as well as H₂O in amorphous form; the 1250-850 cm⁻¹ region is characteristic of sucrose (C—O, C—C, C—O—H), also, in this region and over far infrared is where digital fingerprints of most functional groups are found.

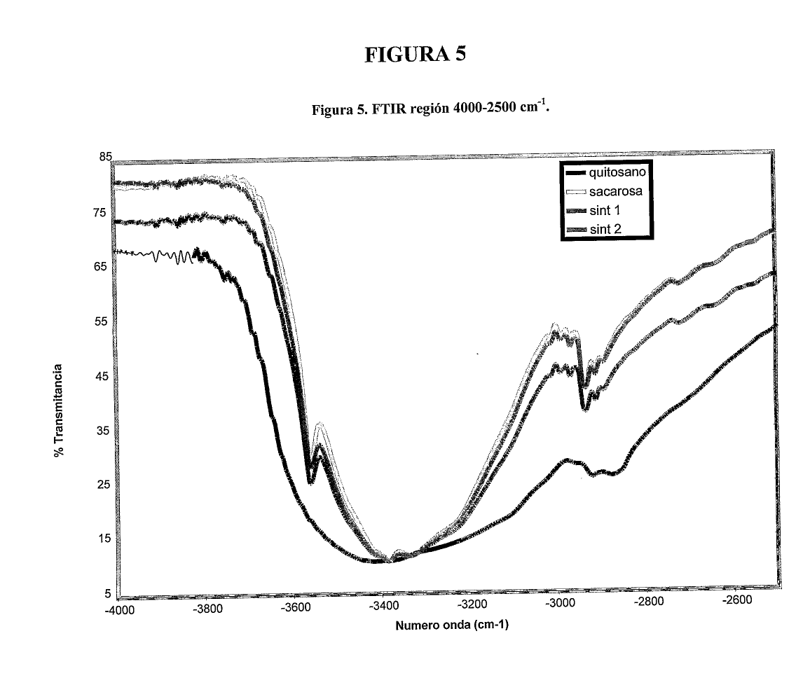

FIG. 5 shows said three regions which in this case is of great interest; the four samples analyzed are found superposed in order to compare both qualitatively as well as quantitatively the target functional groups.

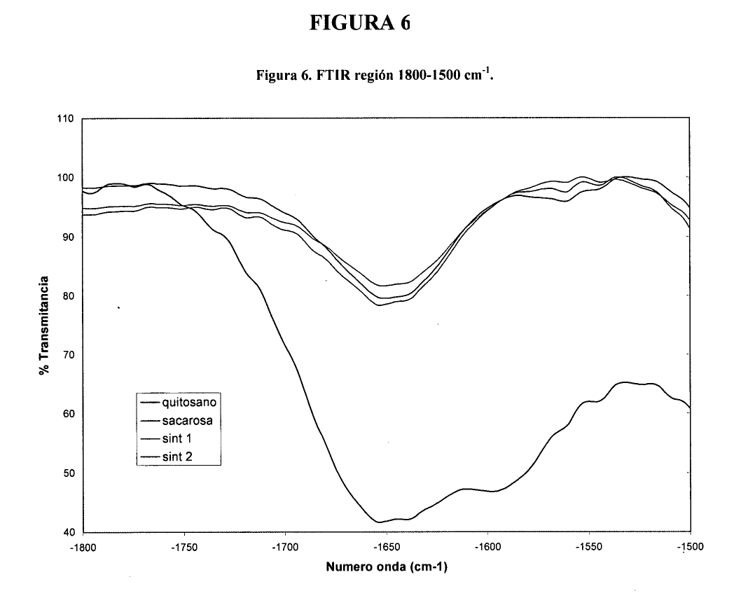

It can be concluded from FIG. 6 that chitosan's greatest amplitude is presented due to two factors, the great density of amino groups (NH₂) and the great amount of hydroxyl groups possessed (—OH), resulting in constructive vibration in this region. For the other three samples (sugar-sint1-sint2), it is understood that the sucrose precursor, because it is a commercial product, is low in humidity (in order to avoid rapid biodegradation), its band being the narrowest, whilst synthesis 1 (sint1) and synthesis 2 (sint2) simply differ in drying time, (t₁=72±0.1 h, t₂=120±0.1 h, respectively), suggesting that synthesis 1 will have a greater amount of water bonded (hydrogen bonds) with the final molecule, obtaining a slightly wider peak in comparison to synthesis 2. Hence, when more OH groups exist, either inter or intramolecularly, the absorption peak is wider.

FIG. 6 teaches that chitosan's most acute peak, about 1650 cm⁻¹, corresponds to the absorption band characteristic of amines. In the case of sucrose, the interpretation is carried out starting from the crystallization concept of commercial sugar, since it is probable as explained before that amorphous water be present in the crystalline lattice, attributing this peak to its absorption band. Therefore, it is noted that synthesis 1 has a greater amount of water in its crystalline lattice than synthesis 2.

This same figure highlights at about 1560 cm⁻¹ a small tendency of a peak formation for synthesis 1 and 2, which creates the possibility of estimating the amount of amide groups (substituted or acetylated amines). Considering the above, the areas between peak domes were calculated corresponding to each synthesis, finding that the greatest area corresponded to synthesis 2; it is worth noting that the values are quite small since the synthesis worked with very low concentrations of acetylated chitosan.

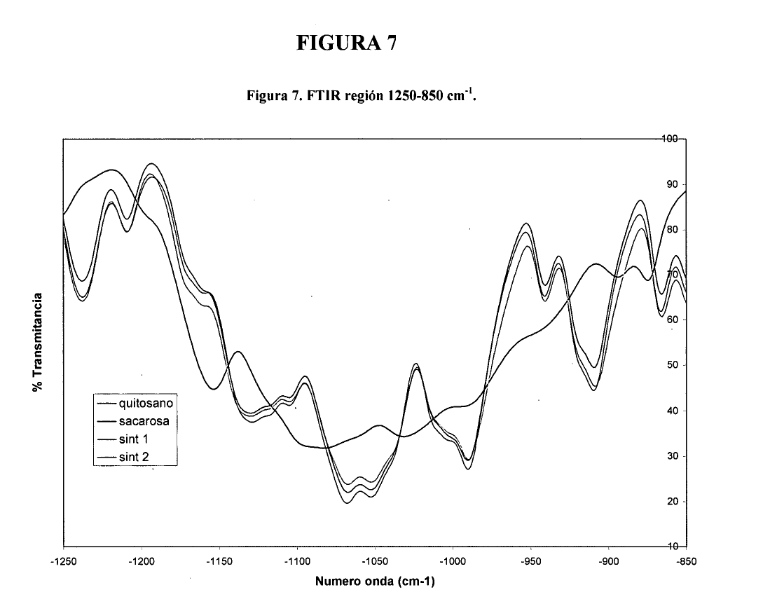

FIG. 7 shows characteristic peaks of sucrose (1129, 1068, 990, 941 cm⁻¹); synthesis spectra in this region have a similar tendency to that of sucrose, due to high sucrose concentrations worked with in the synthesis process.

According to the results obtained by FTIR, it may be suggested that an interaction between the two precursors (chitosan-sucrose) exists in the final product, since the spectra for synthesis 1 and synthesis 2, present vibrations which may be attributed to the presence of chitosan therein.

### Analysis of Results by Scanning Electron Microscopy (SEM)

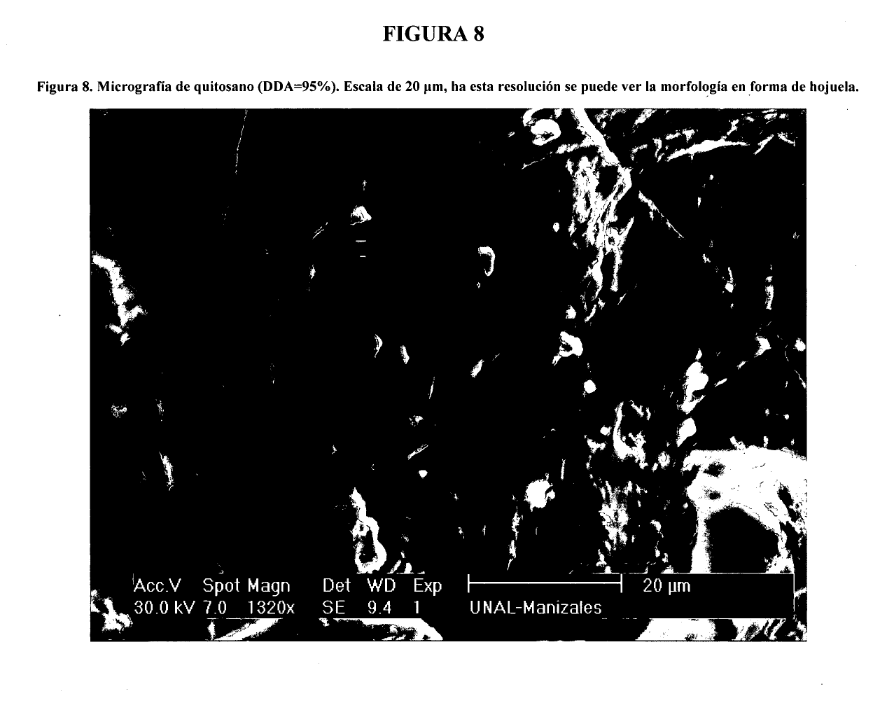

FIG. 8 shows the morphology which crustacean-extracted chitosan possesses; it has a flake like configuration which provides homogenous distribution, for it to be a molecule of the polysaccharide family. Despite carrying out an electron scan over its surface appears to not have altered its morphology.

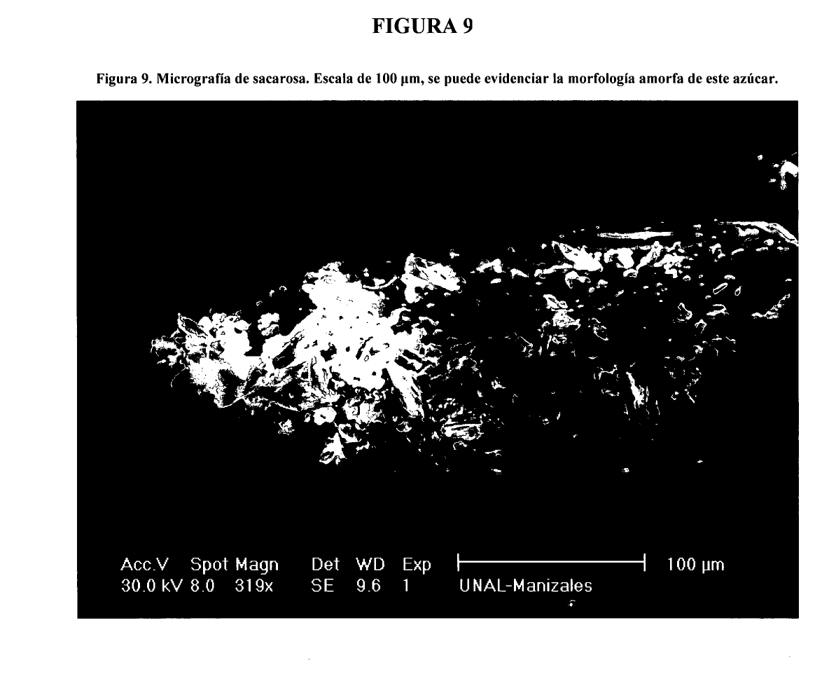

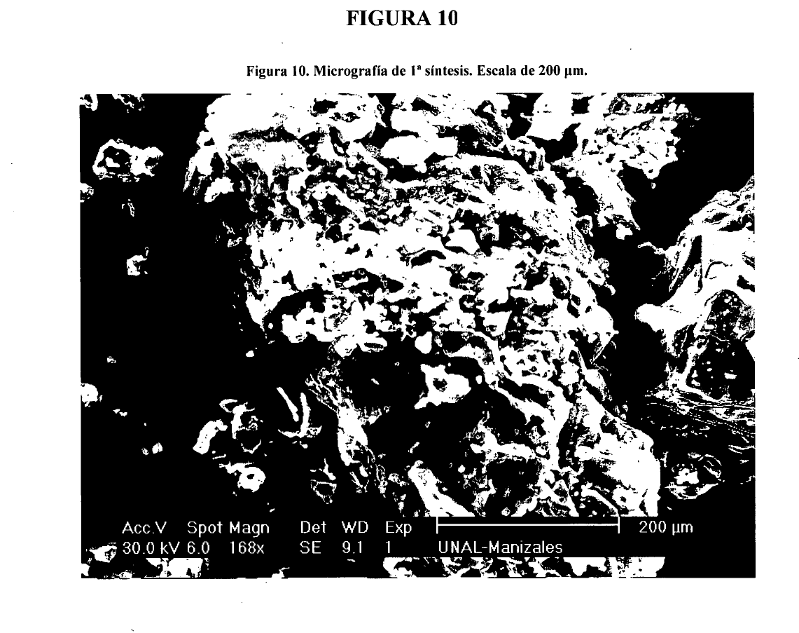

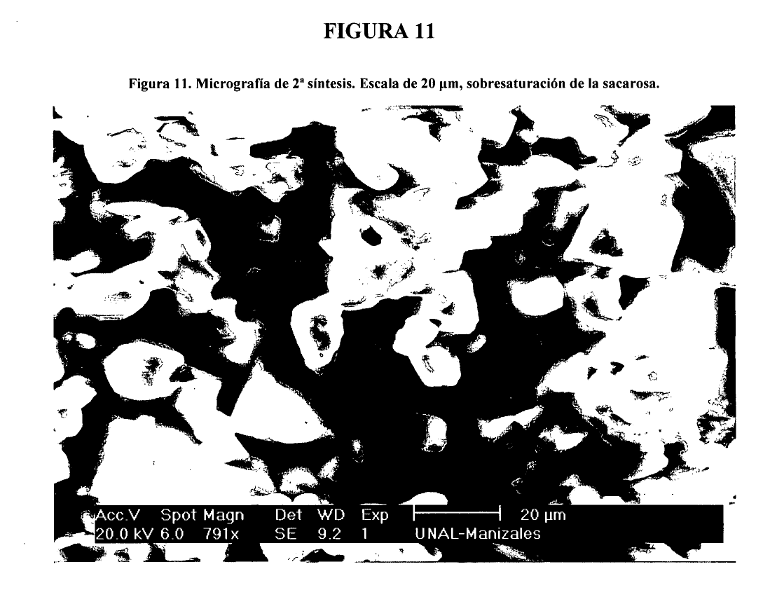

FIGS. 9, 10, 11 show the crystalline structure of sucrose and of the two synthesis (Sint1 and Sint2).

### Second Stage

### Example No. 5

### Oil Encapsulating Protocol²⁸

²⁸Idem 12.

This procedure is reported by Argentine researchers, belonging to the Laboratory of Basic and Applied Research on Chitin (LIBAQ), Chemistry Department, Universidad Nacional del Sur. Following is the method applied step by step:
1. Weigh an amount of material between 0.250-1.000±0.1 g.
2. Prepare 400±1 ml of a 0.1M hydrochloric acid (HCl) solution.
Note 1: the pH value must range between 1.0 and 2.0 in order to simulate the stomach environment.
3. Add the sample amount and shake the blend at 30 r.p.m. during half an hour, maintaining the temperature at 37±2° C.
4. Add between 8.000 and 32.000±0.1 g of sunflower oil to the solution depending on the amount of material solubilized (for example, 0.250±0.1 g material/8.000±0.1 g oil; 1.000±0.1 g material/32.000±0.1 g oil), keep shaking at 30 r.p.m. during one hour at a temperature of 37±2° C.
Note 2: register pH and T (° C.) values.
5. After forming the emulsion, adjust the pH to a value close to 7, slowly adding a 0.2M sodium bicarbonate solution (NaHCO₃), increase shaking speed to 300 r.p.m., keeping temperature at 37±2° C.; after neutralizing, leave shaking for 15 minutes.
Note 3: leave sitting for 30 minutes, in order to allow for the formation of the different phases.

### Determination of Fat Trapping Percentage:

Oil Extraction—Soxlet Method
6. Weigh previously 50±2° C. stove-dried filter paper, in order to avoid humidity content.
7. Separate solid phase from liquid phase; using vacuum filtration equipment. This is done in order to simulate duodenum peristaltic movement.
8. Prepare 200±1 ml of an ethyl ether and petroleum ether solution, at a 1:1 ratio.
9. Place the filter paper in the soxlet extraction equipment.
10. Turn on the equipment and keep solution recirculating during 4±0.1 h over filter paper containing the sample, in order to remove the oil content. This oil must be collected in a collector, previously weighed.
11. Dry the collector containing the extracted solution on a stove at 100±2° C. in order to evaporate traces of solvent.
12. Weigh the amount of oil trapped in the material.

### Oil Extraction—Gravimetric Method

6. Weigh previously 50±2° C. stove-dried filter paper, in order to avoid humidity content.
7. Separate solid phase from liquid phase; using vacuum filtration equipment. This is done in order to simulate duodenum peristaltic movement.
8. Weigh the solid sample over a humid base.
9. Dry over a stove during 24±0.1 hours, in order to remove humidity content.
10. Weigh the solid sample over a dry base.
11. Quantify the content of the oil trapped in the material.

### Example No. 7

### Second Stage Synthesis Protocol

The synthesis protocol in this stage considers the use of a third component different than the precursors, i.e., different food grade acids were used (succinic, adipic, citric, ascorbic, lactic) in order to establish which of them help the final product's functionality, either from a physicochemical point of view and/or commercial perspective. Said protocol is further detailed:
1. Prepare a solution of each acid at different concentrations (0.05M; 0.1M; 0.15M; 0.25M). Measure pH of each solution.
2. Weigh an approximate amount of 500±0.1 mg of material, add them to the solution and solubilize during 4±0.1 hours at room temperature.
Note 1: measure density and pH after solubilization time has passed.
3. Add the sucrose mass and solubilize for one hour; depending on the percentage desired of functional material in the product, carbohydrate amount varies, for example, if 50±1 ml acid solution is prepared and 1% of functional material is desired, 49.5±0.1 g of sucrose is added.
Note 2: after having the oversaturated sucrose solution, log pH and density.
4. Concentrate the solution through low temperature heating (under 30° C.) and shaking, until before solidification.
5. A fraction of concentrated solution is centrifuged in order to remove the air contained and is stored at room temperature, in order to obtain the product in the form of a syrup.
6. A fraction of the solution crystallizes using the low temperature heating method.
   As a preferred embodiment of the invention, using the third agent to obtain the products is opted for, in order to implement neutral pH solubility without carrying out physicochemical modification in the precursors (amino sugar and carbohydrate) as illustrated in this second stage of development. In addition, the syrup presentation of the product obtained from this synthesis procedure is of interest as a raw material in food industries.

### Crystallization

This procedure was carried out in the same manner as described in the first stage.

### Fat Trapping Results

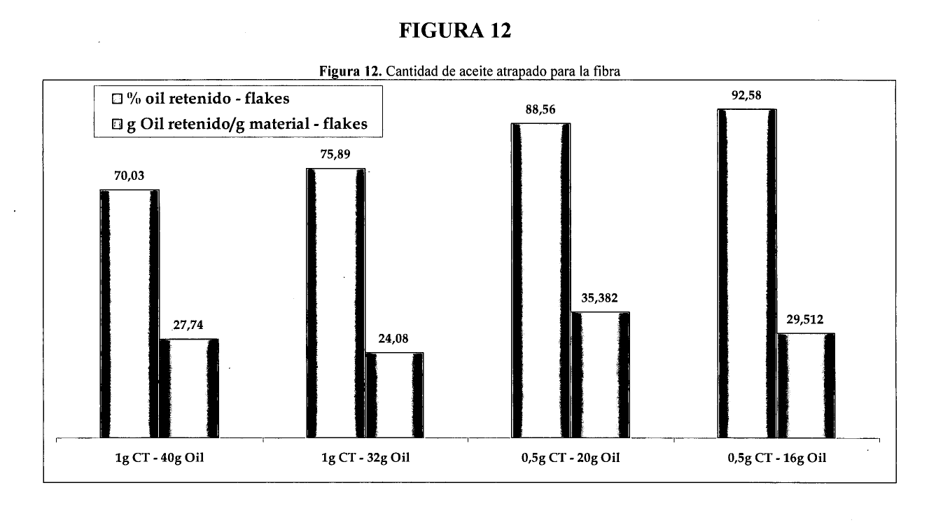

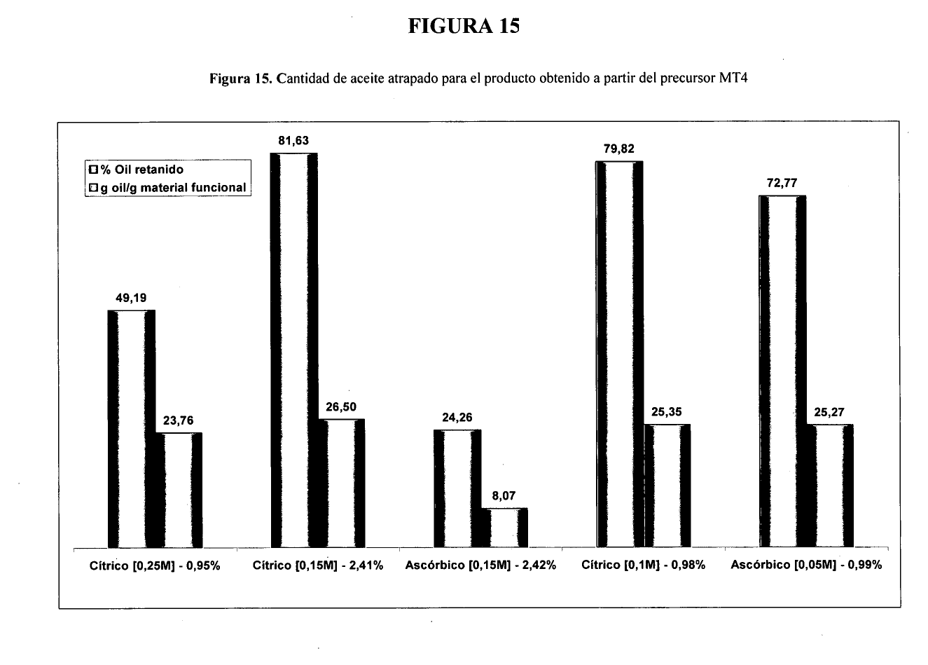

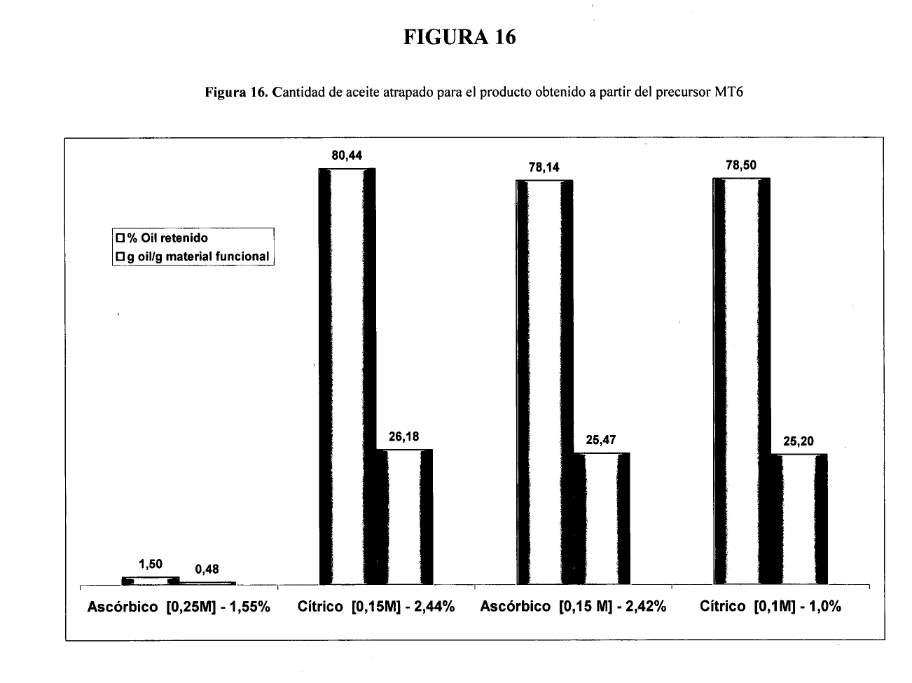

Below are test results of the fat trapping test obtained both for products carried out in the first stage (Table 6), for fiber (FIG. 12), with which a dosage was intended to be established; as well as for commercial precursors and products obtained thereof (FIGS. 15, 16), i.e., when the third agent was included. Likewise, products obtained from different precursors were graphed such as function of acid used, in order to establish which one of them presented better characteristics.

TABLE 6
Oil trapping results for first stage materials

| | Avr | | | | | | g Oil/g |
|---|---|---|---|---|---|---|---|
| | molecular | DDA | Product | Mass | Mass | % OIL | functional |
| Sample | weight (kDa) | (%) | mass (g) | Matᵢ (g) | Oilᵢ (g) | retained | Material |
| M_O4d | 10.501 | N.D. | 4.2 ± 0.1 | 0.250 ± 0.01 | 8.023 ± 0.1 | 5.51 | 1.77 |
| M_O3c | 13.437 | N.D. | 3.192 ± 0.1 | 0.250 ± 0.01 | 7.993 ± 0.1 | 12.55 | 4.01 |

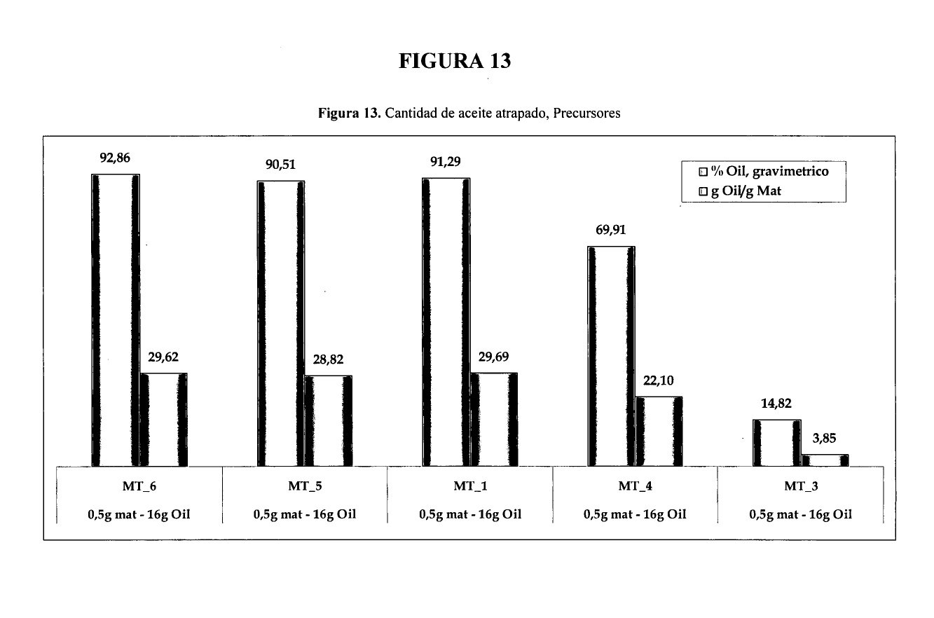

Several amounts of material were tested in several amounts of oil, in order to establish an optimal ratio of amount of material vs amount of oil present in the process. From FIGS. 12 and 13 it is concluded that the dosage having the best response to the trapping test, both for natural fiber and for commercial products is 0.5 g of functional material/16 g oil. Referring to FIG. 12, where natural fiber trapping test results are shown, the dosage presenting better trapping characteristics poses value of 92.58% oil and 29.512 g of oil/g chitosan. This parameter is vital in order to have good standards re oil consumption vs suggested material consumption; hence, this is why it is not necessary to mention characteristics of each sample.

Parting from the oil-precursor ratio defined before (FIG. 12) and from commercial precursors which produced favorable results in the trapping test (FIG. 13), conjugates were prepared with the chosen materials and the third agent (food grade acid) at different concentrations.

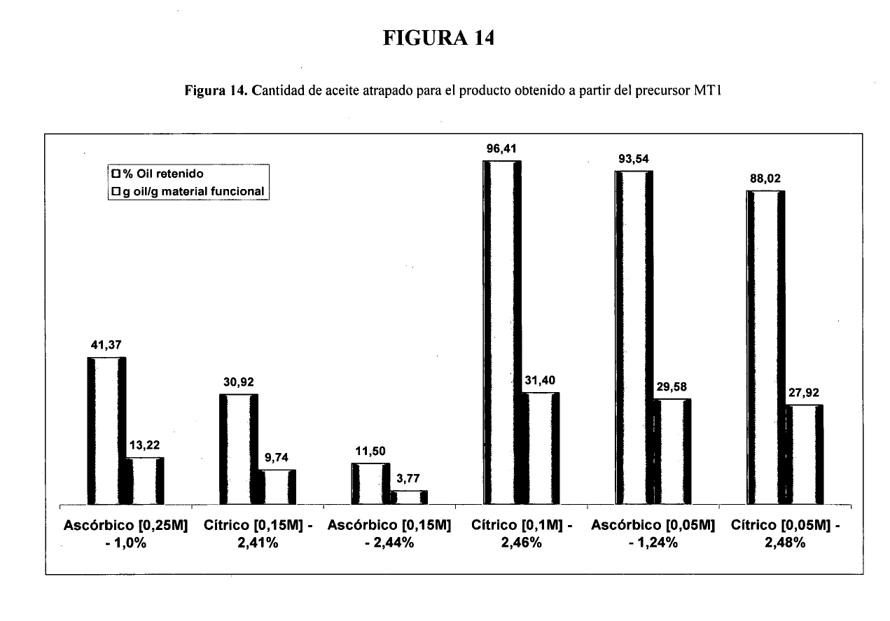

FIG. 14 presents oil trapping results for products obtained from material having a viscosity ranging from 40-60 cps and a DDA ranging from 90-92%; values on the x axis show the acid type and concentration and percentage value refers to the presence of chitosan in the chitosan-carbohydrate conjugate.

FIG. 15 presents oil trapping results for products obtained from material having a viscosity ranging from 30-50 cps and a DDA ranging from 94-96%; values on the x axis show the acid type and concentration and percentage value refers to the presence of chitosan in the chitosan-carbohydrate conjugate.

FIG. 16 presents oil trapping results for products obtained from material having a viscosity ranging from 90-110 cps and a DDA ranging from 84-86%; values on the x axis show the acid type and concentration and percentage value refers to the presence of chitosan in the chitosan-carbohydrate conjugate.

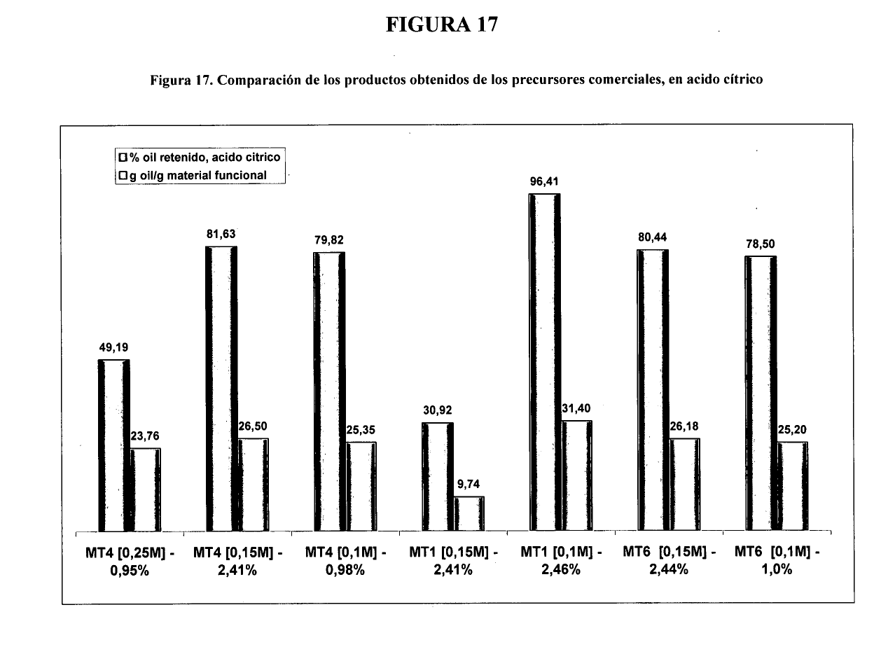

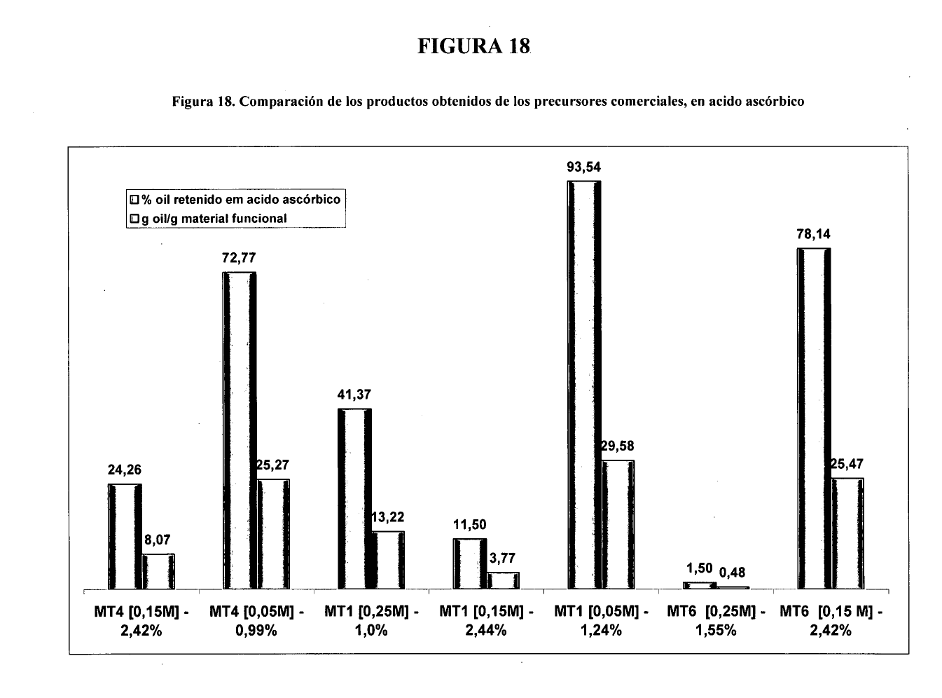

FIGS. 17 and 18, respectively, present trapping results for chitosans used as a function of citric acid and ascorbic acid.

After carrying out trapping tests of products obtained in this research, it is concluded that the trapping percentage depends on the precursor's physicochemical properties, i.e., a degree of deacetylation (DDA)>70% and a viscosity ranging from 40-110 cps. Also, the third agent contributing the best results are ascorbic acid and citric acid, these being of greater interest.

1. A sweetener and fat encapsulating conjugate comprising a derivative of the amino sugar chitin and sweeteners.

2. The conjugate of claim 1 wherein the amino sugar derivative is chitosan.

3. The conjugate of claim 2 wherein the chitosan presents a degree of deacetylation (DDA)>70%, and molecular weight ranging from 20-300 kDa.

4. The conjugate of any of claims 1-3 wherein the sweetener is a carbohydrate.

5. The conjugate of claim 4 wherein the carbohydrate is a mono or disaccharide.

6. The conjugate of claim 4 wherein the carbohydrate is selected from the group consisting of sucrose, glucose, fructose and the different combinations thereof; also, D-ribose, D-arabinose, 2-deoxy-D-glucose, D-mannose, L-fructose, lactose, cellobiose, and maltose.

7. The conjugate of any of claims 1-3 wherein the sweetener is of natural origin.

8. The conjugate of claim 7 wherein the sweetener is rebaudian stevia.

9. The conjugate according to any of the above claims in the form of a granulate solid or in a homogeneous powder and soluble at neutral pH.

10. The conjugate according to any of the above claims in the form of syrup or gel, obtained through drying control, providing particular color and texture characteristics.

11. The conjugate according to any of the above claims in the form of a crystal, obtained through drying from a syrup or gel.

12. A procedure for obtaining the conjugate according to claims 1 through 11, comprising the steps of:
a. depolymerization of the amino sugar through acid hydrolysis, through the use of an acid in order to reduce the polymer chain, bringing it to a low or medium molecular weight (LMW or MMW), and setting it up for further combination with the saccharide;
b. formation of the conjugate by mixing the low or medium molecular weight (LMW or MMW) amino sugar with a concentrated sweetener solution;
c. formation of the conjugate by mixing the low or medium molecular weight (LMW or MMW) amino sugar with a concentrated sweetener solution and the inclusion of a third agent.

13. The process of claim 12 wherein step (c) comprises the following steps:
a. Preparing a water saturated sweetener solution and adding an amount of the depolymerized amino sugar in a ratio ranging 1-10% w/w, for 1-16 hours;
b. Low temperature heat drying between 25 and 30° C.

14. The process of claim 12 wherein step (d) comprises the following steps:
a. preparing a food grade acid solution at a concentration ranging from 0.01-1.0M;
b. adding the low or medium molecular weight polymer to the acid solution;
c. preparing a water solution of saturated sweetener and adding the polymer-containing acid solution to an amount of depolymerized amino sugar in a ration ranging from 1-10% w/w, for 1-16 hours;
d. Low temperature heat drying between 25 and 30° C.

15. The process of claim 14 wherein the solution in step (c) is concentrated at a temperature ranging from 25-30° C., in order to obtain a product in a gel presentation having its own color.
